(19) United States
(12) Patent Application Publication
(10) Pub. No.: US 2026/0049163 A1
(43) Pub. Date: Feb. 19, 2026

(54) SOLVENT SYSTEMS AND METHODS FOR PROCESSING CHITIN

(71) Applicant: Neptune Nanotechnologies Inc., Markham (CA)

(72) Inventor: Qi Guan, Markham (CA)

(73) Assignee: Neptune Nanotechnologies Inc., Markham, ON (CA)

(21) Appl. No.: 19/101,826

(22) PCT Filed: Aug. 8, 2023
(86) PCT No.: PCT/CA2023/051058

§ 371 Date: Feb. 6, 2025

Related U.S. Application Data
(60) Provisional application No. 63/395,915, filed on Aug. 8, 2022.

(51) Int. Cl. C08B 37/08

(52) U.S. Cl. CPC C08B 37/003

(57) ABSTRACT

A method of processing chitin includes dispersing nanocrystalline and amorphous chitin within a solvent system thereby to form a mixture, wherein a solid to solvent ratio in the mixture is no more than 7% wt, the solvent system comprising: a first component comprising: at least one ionic liquid; and at least one inorganic base; and a second component comprising water, wherein the first component comprises no more than 10% by volume of the solvent system; the method further comprising: mechanically agitating and/or boiling the mixture; concentrating the mixture thereby to produce an increased solid to solvent system ratio; rapidly dispersing the concentrated mixture in a cold bath of water and/or water-miscible solvent; and decontaminating and collecting substantially preserved and newly crystallized chitin. Other methods, as well as solvent systems for use in same, are provided.

### CROSS REFERENCE

This application claims priority to U.S. Provisional Patent Application Ser. No. 63/395,915 filed on Aug. 8, 2022, the contents of which are incorporated herein by reference.

### FIELD OF THE INVENTION

The following relates generally to methods of processing chitin and solvent systems for use in same.

### BACKGROUND OF THE INVENTION

Nanoparticles are particles having one or more dimensions between 1 and 100 nanometers (nm). Due primarily to a high percentage of their atoms being positioned at the surface providing a very large surface area for their size, nanoparticles of a given material can exhibit markedly different properties and behaviours than larger particles of the same material.

Nanocomposites are multiple-phase materials, found in nature or fabricated, where one of the phases is nanoparticles. For example, a solid nanocomposite comprises nanoparticles dispersed in a bulk solid matrix. Due to the unique physical properties of nanoparticles, a small percentage of nanoparticles can have noticeable, macro-scale effects on the bulk solid matrix. As such, fabrication of nanocomposites having nanoparticles for imparting beneficial macro-scale mechanical, electrical, optical, dielectrical, thermal, antimicrobial or other effects is of great interest.

Nanofibrils, or nanowhiskers, are nanoparticles having a crystalline rod-like structure. Chitin nanowhiskers include crystalline polysaccharides having a diameter of about 10 nm and a length of about 200 nm to about 500 nm that may be found in an abundant, biodegradable and non-toxic structural polysaccharide material found in crustaceans such as shrimp and crab, known as chitin. Chitin nanowhiskers are desirable for nanocomposites due to their ability to impart desirable mechanical and antimicrobial effects, as well as due to their biodegradability, their abundance and their non-toxicity.

In nature, chitin contains both amorphous and crystalline chitin along with various other components such as proteins and the like. For use in nanocomposites, it is desirable to extract or produce mostly individual chitin nanowhiskers from the chitin so that the individual nanowhiskers can be dispersed throughout a bulk matrix. As such, it is desirable to process the chitin material to generally extract or produce only individualized chitin nanowhiskers, and to include along with the individualized chitin nanowhiskers very little or no agglomerated chitin.

Known acid hydrolysis processes can yield chitin nanowhiskers from chitin material. For example, U.S. Pat. No. 9,169,376 to Guan discloses a method of processing chitin including forming a non-colloidal mixture substantially of chitin and hydrochloric acid to subject the chitin to hydrolysis; upon the mixture becoming substantially colloidal, controlling conditions of the mixture to slow the hydrolysis; dialyzing the substantially colloidal mixture to produce a processed colloidal mixture consisting substantially of water and crystalline chitin; and reducing amount of agglomerated crystalline chitin and water in the processed colloidal mixture thereby to yield chitin nanowhisker gel in which the amount of agglomerated and amorphous chitin has been reduced. While known acid hydrolysis processes such as that disclosed in the '376 patent can be reasonably effective at managing the agglomeration issue by enabling exercise of precise timing of hydrolysis, improvements are desirable.

Other methods for processing raw chitin to produce non-agglomerated chitin nanowhiskers involve fully dissolving raw chitin in an ionic liquid solvent, and regenerating nanocrystals from the fully-dissolved chitin. Because they are essentially built from the “ground up”, such regenerated nanocrystals can be of very high quality. However, known methods for processing chitin using ionic liquids can be extremely expensive, particularly due to the cost of the ionic liquids themselves. Furthermore, ionic liquid residues may introduce contamination, causing adverse effects in sensitive applications.

### SUMMARY

In accordance with an aspect, there is provided a method of processing chitin comprising: dispersing nanocrystalline and amorphous chitin within a solvent system thereby to form a mixture, wherein a solid to solvent ratio in the mixture is no more than 7% wt, the solvent system comprising: a first component comprising: at least one ionic liquid; and at least one inorganic base; and a second component comprising water, wherein the first component comprises no more than 10% by volume of the solvent system; the method further comprising: mechanically agitating and/or boiling the mixture; concentrating the mixture thereby to produce an increased solid to solvent system ratio; rapidly dispersing the concentrated mixture in a cold bath of water and/or water-miscible solvent; and decontaminating and collecting substantially preserved and newly crystallized chitin.

In an example, the solvent system comprises multiple ionic liquids.

In an example, each of the multiple ionic liquids is selected from the group consisting of: 1-ethyl-3-methylimidazolium acetate, 1-butyl-3-methyl-imidazolium chloride, and 1-allyl-3-methylimidazolium bromide.

In an example, the second component further comprises alcohol.

In an example, the alcohol is selected from the group consisting of: ethanol, methanol, isopropyl alcohol, t-butyl alcohol, 2-propanol, and benzyl alcohol.

In an example, the at least one inorganic base is selected from the group consisting of: sodium hydroxide, calcium iodide, calcium chloride, calcium bromide, lithium thiocyanate, and combinations thereof.

In an example, wherein rapidly dispersing the concentrated mixture in a cold bath of water and/or water-miscible solvent comprises dispersing using nozzle jets or spray jets.

According to another aspect, there is provided a method of processing chitin comprising: dispersing nanocrystalline and amorphous chitin within a solvent system thereby to form a mixture, wherein a solid to solvent ratio in the mixture is no more than 7% wt, the solvent system comprising: a first component comprising: at least one deep eutectic solvent; and at least one inorganic base; and a second component comprising water, wherein the first component comprises no more than 10% by volume of the solvent system; the method further comprising: mechanically agitating and/or boiling the mixture; concentrating the mixture thereby to produce an increased solid to solvent system ratio; rapidly dispersing the concentrated mixture in a cold bath of water and/or water-miscible solvent; and decontaminating and collecting substantially preserved and newly crystallized chitin.

In an example, the solvent system comprises multiple deep eutectic solvents.

In an example, the second component further comprises alcohol.

In an example, the alcohol is selected from the group consisting of: ethanol, methanol, isopropyl alcohol, t-butyl alcohol, 2-propanol, and benzyl alcohol.

In an example, the at least one inorganic base is selected from the group consisting of: sodium hydroxide, calcium iodide, calcium chloride, calcium bromide, lithium thiocyanate, and combinations thereof.

According to another aspect, there is provided a solvent system for causing amorphous phase chitin to at least semi-dissolve while substantially preserving nanocrystalline phase chitin, the solvent system comprising: a first component comprising: at least one ionic liquid; and at least one inorganic base; and a second component comprising water, wherein the first component comprises no more than 10% by volume of the solvent system.

According to another aspect, there is provided a solvent system for causing amorphous phase chitin to at least semi-dissolve while substantially preserving nanocrystalline phase chitin, the solvent system comprising: a first component comprising: at least one deep eutectic solvent; and at least one inorganic base; and a second component comprising water, wherein the first component comprises no more than 10% by volume of the solvent system.

According to another aspect, there is provided a method comprising: receiving a mixture of nanocrystalline phase chitin and amorphous phase chitin; forming a combination of the mixture with a solvent system, the solvent system configured to cause the amorphous phase chitin to at least semi-dissolve while substantially preserving the nanocrystalline phase chitin; concentrating the combination thereby to increase the solid to solvent ratio; rapidly dispersing the concentrated combination into a cold bath thereby to cause the at least semi-dissolved amorphous phase chitin to precipitate and thereafter newly crystallize along planes of the substantially preserved nanocrystalline chitin; and decontaminating and collecting the substantially preserved and newly-crystallized chitin from the cold bath.

### BRIEF DESCRIPTION OF THE FIGURES

Examples will be described in further detail with reference to the figures, in which:

FIG. 1 is a flowchart showing a method of processing chitin; and

FIG. 2 is a flowchart showing another method of processing chitin.

### DETAILED DESCRIPTION

Inputs to a new method for processing chitin may be the outputs of a predecessor process, such as an acid hydrolysis process, which itself can provide chitin nanocrystals with amorphous regions attached to crystalline regions.

These inputs can then be treated using a particular solvent system that may contain a combination of one or more types of ionic liquid, and other solvent constituents in very minor but precisely defined concentrations (<10% by volume), where the remaining component of the solvent system is water. This treatment is also controlled in terms of temperature, time and mechanical agitation.

While it has not yet been tried as at the time of this writing, it is predicted that on the basis of the findings disclosed herein and due to their being chemically analogous to ionic liquids, one or more deep eutectic solvents may be used in place of such ionic liquids, and thus may operate in respect of chitin in the same manner as the ionic liquids disclosed herein.

The treatment converts the amorphous chitin phases (solid) into a semi-dissolved state where the amorphous chitin polymer chains have freedom of mobility. Importantly, this solvent system treatment does not impact the state of the crystalline phases. This is believed to be due to the tightly packed crystal structure, and different swelling behaviour compared to amorphous phases, such that the solvent system interacts with the amorphous phase chitin differently than the crystalline phase chitin.

Methods such as centrifuge or membrane filtration or any other method to squeeze out the solvents can thereafter be used. After this, what results is a very high concentrations of chitin nanocrystals, with “tails” of semi dissolved amorphous chitin polymer chains in a mobile state attached to them, sitting in aqueous solvent.

This whole mixture can then be subjected to new conditions under which the semi dissolved amorphous chitin polymer chains (“tails”) are rapidly solidified. By carefully controlling this process, the polymer chains tend to solidify in an orderly fashion along the crystal planes of nearby chitin nanocrystal. Advantageously, this effectively uses the existing nanocrystals that had been preserved in the solvent system while amorphous phase chitin was being dissolved or semi-dissolved, as the seed crystals.

This provides high quality nanocrystals without amorphous regions, due to the previous amorphous phase chitin having been recrystallized.

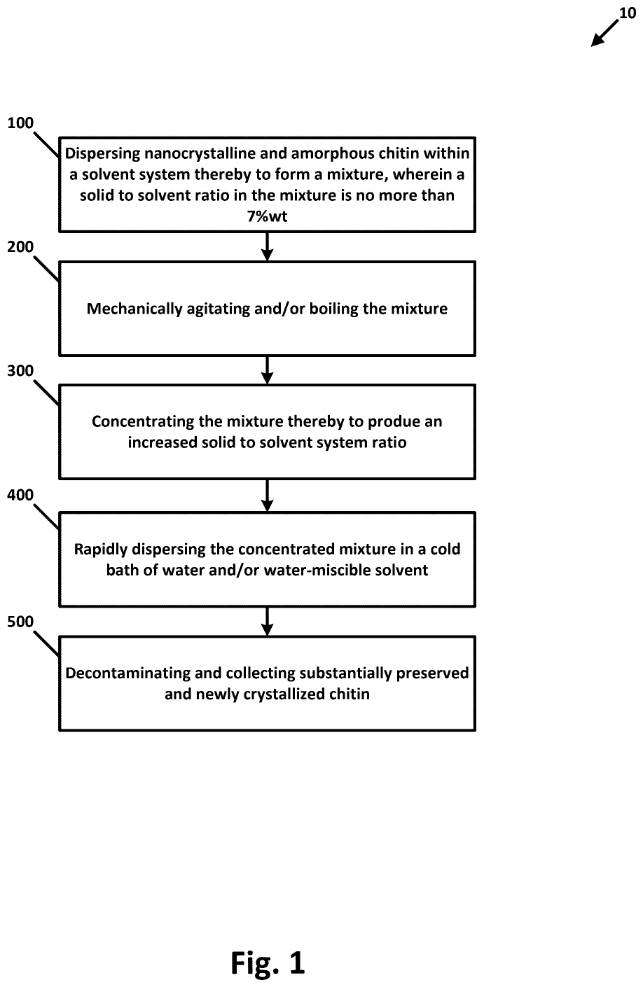

FIG. 1 is a flowchart showing a method 10 of processing chitin according to the present disclosure. During method 10, nanocrystalline and amorphous chitin are dispersed within a solvent system thereby to form a mixture, wherein a solid to solvent ratio in the mixture is no more than 7% wt (step 100). It will be appreciated that, in some examples, the solvent system may include a first component comprising: at least one ionic liquid; and at least one inorganic base; and a second component comprising water, wherein the first component comprises no more than 10% by volume of the solvent system.

Furthermore, during method 10, the mixture is mechanically agitated and/or boiled (step 200), and the mixture is concentrated thereby to produce an increased solid to solvent system ratio (step 300). The concentrated mixture is then rapidly dispersed in a cold bath of water and/or water-miscible solvent (step 400), and substantially preserved and newly crystallized chitin is decontaminated and collected (step 500).

The main benefit of this method is that it still uses a process such as acid hydrolysis to output amorphous phase and nanocrystalline phase chitin as the inputs to the new method. Processes such as acid hydrolysis can be efficient, low cost and scalable. Furthermore, the method itself uses very little quantities of expensive complex solvents and other materials to keep the cost and the contamination issues in check. However, the new method is being demonstrated to yield chitin nanocrystals that have quality almost on par with far more expensive methods that grow all crystals from the bottom up.

The outputs of the new method can be used as a new nanocrystal baseline, usable in new applications such as polymer master batches, epoxy concentrates, and others.

### Particular Example

1. A known HCl (Hydrochloric Acid) acid hydrolysis process may be conducted to yield chitin nanocrystals (nanowhiskers) that additionally have some agglomeration and amorphous phase chitin attachments.

2. These may optionally be subjected to lyophilisation (freeze drying) to produce a powder form, before subsequent processing steps are conducted.

It will be appreciated that the outputs of the above steps 1 (and optionally 2) will be semi-good chitin nanocrystal material, but with some significant agglomeration and amorphous phase attachments. It will be appreciated that an HCl acid hydrolysis process is one example of a process that can produce semi-good chitin nanocrystal but with agglomeration and amorphous phase attachments. This disclosure is not limited to receiving and operating on outputs of an HCl acid hydrolysis process in particular, as the outputs of other processes that produce chitin nanocrystal that has agglomeration and amorphous phase attachment problems may be processed successfully using the below steps.

3. Disperse the chitin nanocrystal into an aqueous solvent with the following constituents:
Ionic Liquid family: (1-ethyl-3-methylimidazolium acetate, 1-butyl-3-methyl-imidazolium chloride, 1-ally1-3-methylimidazolium bromide,)
(NOTE: It is predicted that Deep Eutectic Solvents may be used in place of ionic liquids as they can be chemically analogous, but this hasn't been tried as at the time of this writing)
At least one inorganic base: (for example, selected from the group consisting of: sodium hydroxide, calcium iodide, calcium chloride, calcium bromide, and lithium thiocyanate)
Additional Solvents: (N, N-Dimethylacetamide, LiCl, CaCl₂)
Where the combination of the above solvents does not exceed 10% (0.1% to 10%) by volume, the remaining solvent is water and Alcohol.
Alcohol: (ethanol, methanol, isopropyl alcohol, t-butyl alcohol, 2-propanol, benzyl alcohol)
Solid to Solvent ratio does not exceed (i.e., comprises no more than) 7% wt.

It has been observed that ionic liquid disrupts the hydrogen bonding on chitin, while inorganic bases and additional solvents aid the disruption. Furthermore, alcohol tunes of polarity of the solvent to better match the polarity of chitin. At the time of this writing, 2 of ionic liquids where the acetate is the primary have been tested, combined with just 1 of the additional solvents and 1 of the inorganic bases family. It is possible that different combinations and numbers of constituents (such as fewer ionic liquids, or more additional solvents or more inorganic bases) may function as well or better than the combination set forth above. Alcohol quantities depends on their relative polarity, such that the less polar it is, the less alcohol that is needed.

4. The whole mixture is then subjected to boiling under aggressive mechanical agitation for between 15 min and 90 min.

The function of these steps is to cause the amorphous phase of chitin to enter a semi-dissolved state, where the polymer chains are sufficiently swelled and mobile, however without in doing so disturbing the nanocrystal phases themselves.

5. The mixture is then concentrated as much as possible, such as by using filtration (so as to maintain solvent ratios during concentration) or by boiling for evaporation.

6. The now-concentrated mixture is then rapidly dispersed into a bath of cold water. It is anticipated that other water miscible solvents may be viable in lieu of, or in combination with, water. This is most advantageously done rapidly and with a small droplet size, such as by using nozzle jets or spray jets.

This concentration and then rapid dispersal is for rapidly eliminating the condition that allows amorphous chitin to be semi or fully dissolved. The inventor observes that chitin has the natural tendency to crystalize, and it crystalizes along existing crystal planes rather than nucleating new crystals if possible. That is, it minimizes Gibbs free energy. Advantageously, the existing chitin crystals that have been preserved in the solvent while its amorphous chitin counterparts have been encouraged to dissolve or semi-dissolve, essentially act as seed crystals on which additional crystal layers are grown from the formerly-amorphous chitin.

7. The chitin-dispersed bath is then washed and/or filtered to remove possible chemical residues. The mixture is then concentrated into a water gel, dried, and/or loaded into other solvents or carrier resins for downstream processing and/or to form nanocomposites.

The above-described methods receive chitin material that includes nanocrystals (nanowhiskers) that may have some agglomeration and amorphous phase chitin attachments, use a solvent system to dissolve or semi-dissolve the amorphous phase chitin while preserving the chitin that is in nanocrystal form, and then control conditions in the solution to cause the dissolved or semi-dissolved amorphous chitin to rapidly leave solution (precipitate) and immediately crystallize along the existing crystal planes of the preserved nanocrystal forms. It will be appreciates that modifications to the above-described methods, such as to use more or fewer or different ionic liquids, to use deep eutectic solvents, to use more or fewer additional solvents, to use more or fewer inorganic bases, to subject the mixture to just boiling and no mechanical agitation, to subject the mixture to no boiling and just mechanical agitation, or conduct boiling and/or mechanical agitation for longer or shorter times, or at intervals, and other modifications to the basic process, may be partially or wholly successful for converting the amorphous phase chitin into crystalline phase chitin while preserving the initially crystalline phase chitin throughout so it can remain intact and also serve as seed crystal for the forming new crystallization.

Various alternatives are possible.

For example, during method 10 shown in FIG. 1, the solvent system may include a first component comprising: at least one deep eutectic solvent; and at least one inorganic base; and a second component comprising water, wherein the first component comprises no more than 10% by volume of the solvent system.

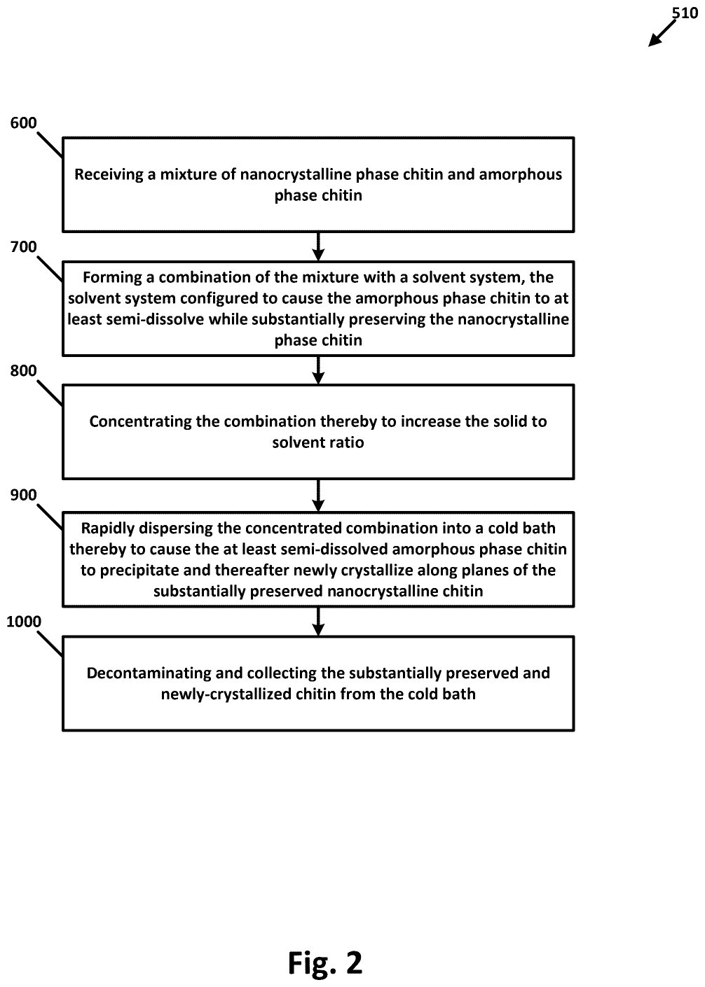

Furthermore, based on the principles disclosed herein in which a solvent system may be formulated and applied to act favourably on chitin for the objects disclosed herein, similar but different methods for processing chitin may be provided. For example, with reference to FIG. 2, a method 510 may include receiving a mixture of nanocrystalline phase chitin and amorphous phase chitin (600). A combination of the mixture with a solvent system may be formed, with the solvent system configured to cause the amorphous phase chitin to at least semi-dissolve while substantially preserving the nanocrystalline phase chitin (step 700). The combination may be concentrated thereby to increase the solid to solvent ratio (step 800), and the concentrated combination may be rapidly dispersed into a cold bath thereby to cause the at least semi-dissolved amorphous phase chitin to precipitate and thereafter newly crystallize along planes of the substantially preserved nanocrystalline chitin (step 900). The substantially preserved and newly-crystallized chitin may be decontaminated and collected from the cold bath (step 1000).

What is claimed is:

1. A method of processing chitin comprising:
dispersing nanocrystalline and amorphous chitin within a solvent system thereby to form a mixture, wherein a solid to solvent ratio in the mixture is no more than 7% wt, the solvent system comprising:
a first component comprising:
at least one ionic liquid; and
at least one inorganic base;
and
a second component comprising water,
wherein the first component comprises no more than 10% by volume of the solvent system;
the method further comprising:
mechanically agitating and/or boiling the mixture;
concentrating the mixture thereby to produce an increased solid to solvent system ratio;
rapidly dispersing the concentrated mixture in a cold bath of water and/or water-miscible solvent; and
decontaminating and collecting substantially preserved and newly crystallized chitin.

2. The method of claim 1, wherein the solvent system comprises multiple ionic liquids.

3. The method of claim 2, wherein each of the multiple ionic liquids is selected from the group consisting of: 1-ethyl-3-methylimidazolium acetate, 1-butyl-3-methyl-imidazolium chloride, and 1-ally1-3-methylimidazolium bromide.

4. The method of claim 1, wherein the second component further comprises alcohol.

5. The method of claim 4, wherein the alcohol is selected from the group consisting of: ethanol, methanol, isopropyl alcohol, t-butyl alcohol, 2-propanol, and benzyl alcohol.

6. The method of claim 1, wherein the at least one inorganic base is selected from the group consisting of: sodium hydroxide, calcium iodide, calcium chloride, calcium bromide, lithium thiocyanate, and combinations thereof.

7. The method of claim 1, wherein rapidly dispersing the concentrated mixture in a cold bath of water and/or water-miscible solvent comprises dispersing using nozzle jets or spray jets.

8. A method of processing chitin comprising:
dispersing nanocrystalline and amorphous chitin within a solvent system thereby to form a mixture, wherein a solid to solvent ratio in the mixture is no more than 7% wt, the solvent system comprising:
a first component comprising:
at least one deep eutectic solvent; and
at least one inorganic base;
and
a second component comprising water,
wherein the first component comprises no more than 10% by volume of the solvent system;
the method further comprising:
mechanically agitating and/or boiling the mixture;
concentrating the mixture thereby to produce an increased solid to solvent system ratio;
rapidly dispersing the concentrated mixture in a cold bath of water and/or water-miscible solvent; and
decontaminating and collecting substantially preserved and newly crystallized chitin.

9. The method of claim 8, wherein the solvent system comprises multiple deep eutectic solvents.

10. The method of claim 8, wherein the second component further comprises alcohol.

11. The method of claim 10, wherein the alcohol is selected from the group consisting of: ethanol, methanol, isopropyl alcohol, t-butyl alcohol, 2-propanol, and benzyl alcohol.

12. The method of claim 8, wherein the at least one inorganic base is selected from the group consisting of: sodium hydroxide, calcium iodide, calcium chloride, calcium bromide, lithium thiocyanate, and combinations thereof.

13. A solvent system for causing amorphous phase chitin to at least semi-dissolve while substantially preserving nanocrystalline phase chitin, the solvent system comprising:
a first component comprising:
at least one ionic liquid; and
at least one inorganic base;
and
a second component comprising water,
wherein the first component comprises no more than 10% by volume of the solvent system.

14. A solvent system for causing amorphous phase chitin to at least semi-dissolve while substantially preserving nanocrystalline phase chitin, the solvent system comprising:
a first component comprising:
at least one deep eutectic solvent; and
at least one inorganic base;
and
a second component comprising water,
wherein the first component comprises no more than 10% by volume of the solvent system.

15. A method comprising:
receiving a mixture of nanocrystalline phase chitin and amorphous phase chitin;
forming a combination of the mixture with a solvent system, the solvent system configured to cause the amorphous phase chitin to at least semi-dissolve while substantially preserving the nanocrystalline phase chitin;
concentrating the combination thereby to increase the solid to solvent ratio;
rapidly dispersing the concentrated combination into a cold bath thereby to cause the at least semi-dissolved amorphous phase chitin to precipitate and thereafter newly crystallize along planes of the substantially preserved nanocrystalline chitin; and
decontaminating and collecting the substantially preserved and newly-crystallized chitin from the cold bath.
